(19) United States
(12) Patent Application Publication
(10) Pub. No.: US 2015/0168167 A1
(43) Pub. Date: Jun. 18, 2015

(54) SYSTEM AND METHOD OF PROVIDING WEATHER INFORMATION

(71) Applicant: Hyundai Motor Company, Seoul (KR)

(72) Inventors: Chang Sik Hwang, Seoul (KR); Seung-Chang Park, Seoul (KR)

(21) Appl. No.: 14/467,581

(22) Filed: Aug. 25, 2014

(30) Foreign Application Priority Data
Dec. 18, 2013 (KR) 10-2013-0158409

(51) Int. Cl. G01C 21/34

(52) U.S. Cl. CPC G01C 21/34

(57) ABSTRACT

A system and a method of providing weather information to a driver of a vehicle along a desired route are provided. The method includes setting, by a controller, the desired route from a current position of a vehicle to a destination and transmitting information regarding the desired route to a telematics server. In addition, the controller is configured to receive current weather information that corresponds to the desired route from the telematics server and map the current weather information with map data to display the mapped current weather information on a user interface.

### CROSS-REFERENCE TO RELATED APPLICATION

This application claims priority to and the benefit of Korean Patent Application No. 10-2013-0158409 filed in the Korean Intellectual Property Office on Dec. 18, 2013, the entire contents of which are incorporated herein by reference.

### BACKGROUND

(a) Field of the Invention

The present invention relates to a system and a method of providing weather information, and more particularly, to a system and a method of providing weather information, that collect and provide weather information via a telematics service.

(b) Description of the Related Art

Telematics is a term combining of telecommunication and informatics, and is defined as a next generation information providing service for a vehicle using a combination of an IT industry, in which wireless communication, a vehicular terminal, contents, and the like are organically connected with each other, and an auto industry. The telematics service may provide various services, such as traffic and driving information, emergency situation handling information, remote vehicle diagnosis service, the Internet, and the like by utilizing a wireless communication technology and a global positioning system (GPS) technology.

Furthermore, rainfall, snowfall, fog, yellow dust, and the like are factors that hinder the safety of a driver. Recently, generation of localized torrential downpours, in which a specific region has a heavy rain for a short period of time, has recently increased. To measure and predict locally generated weather information, an automatic weather system (AWS) is installed at a specific point, but it is difficult to accurately collect weather information with the limited number of AWSs. The additional installation of the AWS to accurately collect weather information requires a substantially high demand of human/material resources, such as investment cost, repair and maintenance, and management manpower.

The above information disclosed in this section is merely for enhancement of understanding of the background of the invention and therefore it may contain information that does not form the prior art that is already known in this country to a person of ordinary skill in the art.

### SUMMARY

The present invention provides a system and a method of providing weather information, which collect and provide weather information of a specific link via a telematics terminal disposed within a vehicle.

An exemplary embodiment of the present invention provides a method of providing weather information that may include: setting a desired route from a current position of a vehicle toward a destination; transmitting information regarding the desired route to a telematics server; receiving current weather information that corresponds to the desired route from the telematics server; and mapping the current weather information with map data and displaying the mapped current weather information.

The current weather information may include current weather information for each link included in the desired route. The current weather information for each link may be generated by the telematics server based on position information and weather state information collected from a plurality of telematics terminals. The current weather information for each link may include at least one of current rainfall amount information, current snowfall amount information, current visibility range information according to fog, and current visibility range information according to yellow dust.

Another exemplary embodiment of the present invention provides a system for providing weather information that may include: a telematics terminal configured to detect data from a data detection unit disposed within a vehicle, and determine a weather state; and a telematics server configured to receive position information regarding the vehicle and weather state information from the telematics terminal, in which the telematics server may be configured to identify a link that corresponds to a position of the vehicle and store the weather state information regarding the corresponding link.

The data detection unit may include a rain sensor configured to detect rainfall, and an imaging device (e.g., a camera, a video camera, or the like) configured to photograph an exterior environment surrounding the vehicle, and the weather state may include rainfall, snowfall, fog, and yellow dust. The telematics terminal may be configured to transmit the position information of the vehicle and the weather state information for each predetermined period. The telematics server may be configured to generate current weather information regarding the corresponding link.

As described above, according to the exemplary embodiments of the present invention, it may be possible to collect weather information about a specific link using the telematics terminal disposed within the vehicle without using a separate device. Further, it may be possible to improve safety for a driver by providing the driver with current weather information.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary configuration diagram illustrating a network of a weather information collecting system according to an exemplary embodiment of the present invention;

FIG. 2 is an exemplary block diagram illustrating a telematics terminal according to an exemplary embodiment of the present invention;

FIG. 3 is an exemplary flowchart illustrating a method of collecting weather information from the telematics terminal by a telematics server according to an exemplary embodiment of the present invention; and

FIG. 4 is an exemplary flowchart illustrating a method of providing weather information according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the art would realize, the described exemplary embodiments may be modified in various different ways, all without departing from the spirit or scope of the present invention. In the present specification, a “node” means a network element corresponding to a crossroad portion in an actual road. In the present specification, a “link” is a network element indicating a connection section in an actual road, which is a connection portion between nodes, and means a network connection section including a start node and an end node.

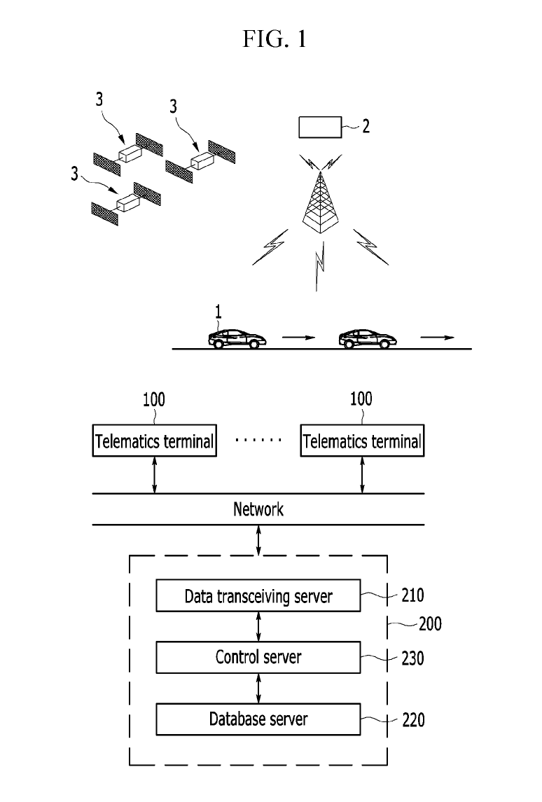

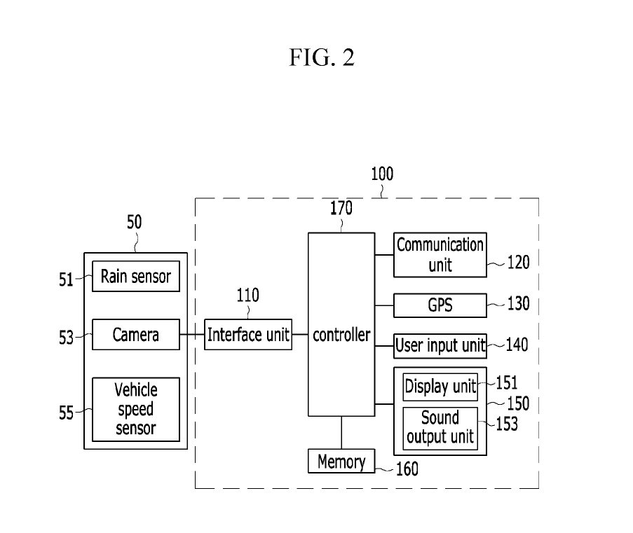

FIG. 1 is an exemplary configuration diagram illustrating a network of a weather information collecting system according to an exemplary embodiment of the present invention. FIG. 2 is an exemplary block diagram illustrating a telematics terminal according to an exemplary embodiment of the present invention. As illustrated in FIGS. 1 and 2, the weather information collecting system according to the exemplary embodiment of the present invention may include a telematics terminal 100 disposed within a vehicle 1, and a telematics server 200 disposed within a telematics center 2.

The telematics terminal 100 may be configured to receive a GPS signal from three or more artificial satellites 3, and calculate a current position of the vehicle 1 based on the GPS signal and map data. The telematics terminal 100 may be configured to determine weather state based on data detected by a data detection unit 50 disposed within the vehicle 1. The weather state may include rainfall, snowfall, fog, and yellow dust. The data detection unit 50 may be configured to detect data for determining the weather state, and the data detected by the data detection unit 50 may be transmitted to the telematics terminal 100. The data detection unit 50 may include a rain sensor 51, an imaging device 53, and a vehicle speed sensor 55.

The rain sensor 51 may be configured to detect rainfall on a windshield glass of the vehicle. The imaging device 53 may be a black box imaging device used in a black box system installed within the vehicle 1. The imaging device 53 (e.g., a camera, a video camera, or the like) may be installed within the vehicle 1 to photograph the exterior of the vehicle over the windshield glass. The imaging device 53 may be configured to process an image frame of a still image or a video obtained by an image sensor in a photographing mode. The image frame processed by the imaging device 53 may be transmitted to the telematics terminal 100. The vehicle speed sensor 55 may be configured to measure a speed of the vehicle, and may be mounted on a wheel of the vehicle. Additionally, the vehicle speed sensor 55 may also be configured to calculate a vehicle speed based on a GPS signal received by a GPS 130 to be described below.

The telematics terminal 100 may be configured to transmit the position information of the vehicle and the weather state information to the telematics server 200. The telematics terminal 100 may also be configured to transmit the position information of the vehicle and the weather state information to the telematics server 200 for each predetermined period. The telematics server 200 may be configured to collect the position information of the vehicle and the weather state information from the plurality of telematics terminals 100, and generate current weather information about a specific link. The telematics server 200 may be configured to provide an organization measuring weather (e.g., a meteorological agency) with current weather information for each link.

A driver may set a desired route from a current position toward a destination using the telematics terminal 100, and the telematics terminal 100 may be configured to transmit information regarding the desired route to the telematics server 200. When a link that corresponds to the weather state is present in the desired route, the telematics server 200 may be configured to transmit current weather information regarding the corresponding link to the telematics terminal 100. Accordingly, the driver may confirm a link having bad weather (e.g., rain, snow, dust, or any other that may hinder or affect the driving of the vehicle) using the telematics terminal 100, and may make a detour (e.g., choose another route) or be more cautious during driving. Accordingly, as illustrated in FIG. 2, the telematics terminal 100 may include an interface unit 110, a communication unit 120, the GPS 130, a user input unit 140, an output unit 150, a memory 160, and a controller 170. The controller 170 may be configured to operate the interface unit 110, the communication unit 120, the GPS 130, the user input unit 140, the output unit 150, and the memory 160.

The interface unit 110 may be configured to operate as a passage with the external devices connected with the telematics terminal 100. The interface unit 110 may be configured to receive data from the data detection unit 50. The communication unit 120 may be configured to transceive data with the telematics server 200 via a wired or wireless network, such as the Wireless Internet, a wireless phone network, a Wireless LAN (WiFi) network, a 3-generation (3G) network, a 4G long term evolution (LTE) network, a Bluetooth network, a radio frequency identification (RFID) network, an infrared data association (IrDA) network, a ZigBee network, an ultra wideband (UWB) network, and a near field communication (NFC) network.

The GPS 130 may be configured to receive a GPS signal from three or more satellites 3, and calculate position information of the vehicle 1. The position information may include coordinate information indicated with latitude and longitude. The controller 170 may also be configured to calculate a vehicle speed based on the GPS signal. The user input unit 140 may be configured to generate input data to operate the telematics terminal 100 by the user. The user input unit 140 may include a touch pad, a key pad, a jog shuttle, and the like. Particularly, when the touch pad and a display unit 151, which will be described below, form a layer structure, the touch pad may be called a touch screen. The driver may select a destination through the user input unit 140, and set a desired route on which the driver desires to travel.

The output unit 150 may be configured to generate an output related to a visual or auditory sense, and may include the display unit 151 and a sound output unit 153. The display unit 151 may be configured to display information processed by the telematics terminal 100. For example, when the telematics terminal 100 is guiding the route, the display unit 151 may be configured to display a user interface (UI) or a graphic user interface (GUI) related to the guide of the route (e.g. displaying an image of the selected route on an interface). Further, when a link that corresponds to the weather state is present in the set desired route, the display unit 151 may be configured to display corresponding current weather information. The display unit 151 may include a liquid crystal display (LCD), a thin film transistor liquid crystal display (TFT LCD), an organic light emitting diode (OLED), a flexible display, a 3D display, and the like. When the display unit 151 and a sensor configured to detect a touch motion (hereinafter, referred to as a “touch sensor”) form a layer structure, the display unit 151 may be used as an input device, in addition to an output device.

The sound output unit 153 may be configured to output audio data received from the communication unit 120 or stored in the memory 160. The sound output unit 153 may be configured to output a sound signal related to a function (for example, the guide of a route) performed by the telematics terminal 100. The sound output unit 153 may include a receiver, a speaker, a buzzer, and the like. The memory 160 may be configured to store a program for an operation of the controller 170, and temporarily store input/output data (for example, the rainfall amount, a vehicle speed, acceleration, a still image, and a video). Further, the memory 160 may be configured to store map data for guiding the route.

The memory 160 may include at least one type of storage medium among a flash memory type, a hard disk type, a multimedia card micro type, a card-type memory (for example, an SD or XD memory), a random access memory (RAM), a read-only memory (ROM), an electrically erasable programmable read only memory (EEPROM), a programmable read only memory (PROM), a magnetic memory, a magnetic disk, and an optical disk. Additionally, the controller 170 may be configured to operate the telematics terminal 100, and may be implemented with one or more microprocessors operated by a set program, and the set program may include a series of commands for performing respective steps included in a method of collecting the weather information according to an exemplary embodiment of the present invention, which will be described below.

The controller 170 may be configured to determine a weather state based on the data detected by the data detection unit 50. The weather state may include rainfall, snowfall, fog, and yellow dust. The controller 170 may further be configured to determine whether rainfall or snowfall is generated based on the data detected by the rain sensor 51. The controller 170 may be configured to transmit information regarding the rainfall amount or the snowfall amount to the telematics server 200 via the communication unit 120. When the vehicle speed is increased, the rainfall amount detected by the rain sensor 51 increases, and the controller 170 may be configured to correct the rainfall amount based on a vehicle speed.

The controller 170 may also be configured to determine whether fog or yellow dust is generated based on image data received from the imaging device 53. For example, fog and yellow dust may be present on the photographed image and whether fog or yellow dust is generated may be determined by extracting a representative color expressed on a region of the image data. A white-based color may be set as the representative color of fog, and a yellow-based color may be set as the representative color of yellow dust. However, it shall not be understood that the scope of the present invention is limited thereto, and the invention may be based on extraction of other information according to an intention of a person of an ordinary skill in the art.

The controller 170 may be configured to transmit image information regarding the fog or the yellow dust to the telematics server 200 via the communication unit 120. The telematics server 200 may include a data transceiving server 210, a database server 220, and a control server 230. When the constituent elements are implemented in actual application, two or more constituent elements may be combined into one constituent element, or one constituent element may be configured to be subdivided into two or more constituent elements, if necessary. The data transceiving server 210 may be configured to receive information provided from the plurality of telematics terminals 100 via the network. Further, the current weather information provided from the control server 230 may be transmitted to the telematics terminal 100 via the network. An identifier (ID) for each link may be assigned to the database server 220, and position information regarding a link may be stored in the database server 220. Further, information regarding a weather state may be stored for each link.

The control server 230 may be configured to generate current weather information based on the information received from the information transceiving server 210 and the information stored in the database server 220. When a link that corresponds to the weather state is present in the desired route received from the telematics terminal 100, the control server 230 may be configured to transmit current weather information regarding the corresponding link to the telematics terminal 100 via the information transceiving server 210.

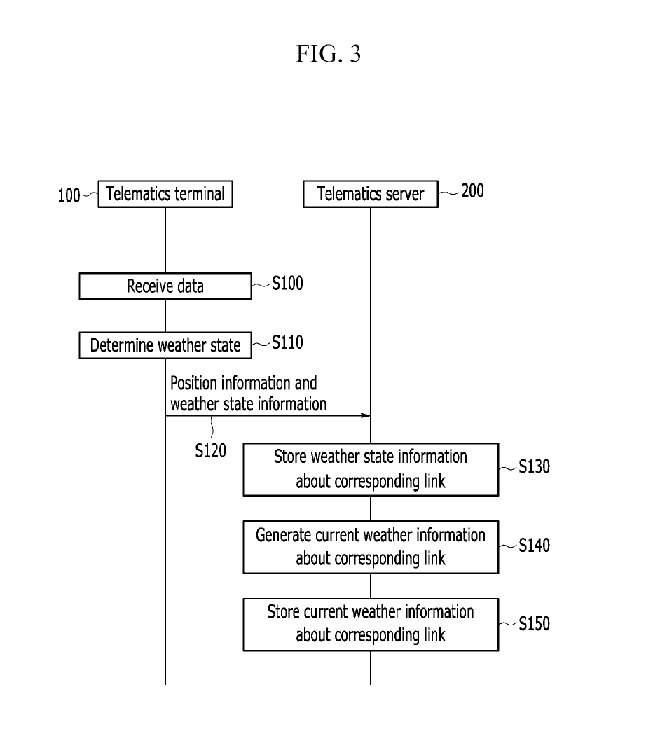

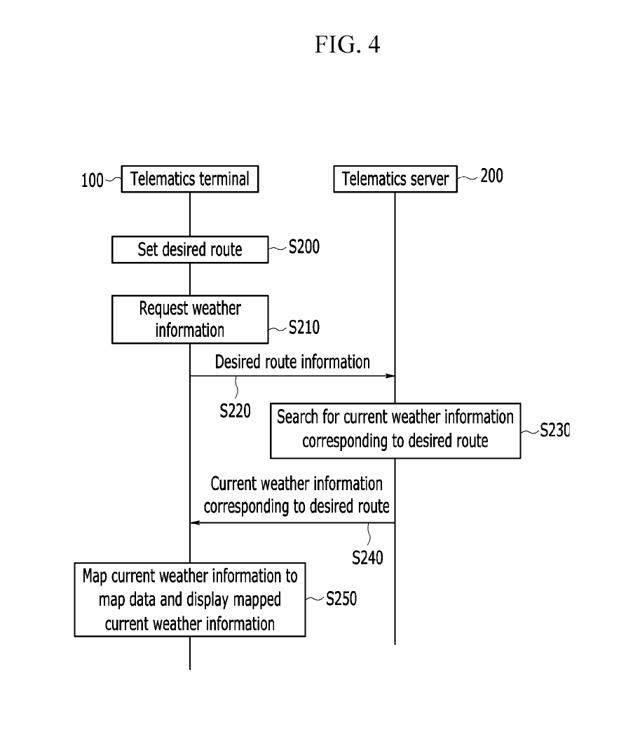

Hereinafter, a method of providing weather information according to exemplary embodiment of the present invention will be described in detail with reference to FIGS. 3 and 4. FIG. 3 is an exemplary flowchart illustrating a method of collecting weather information by a telematics server according to the exemplary embodiment of the present invention. Referring to FIG. 3, a method of collecting weather information according to exemplary embodiment of the present invention starts by receiving, by the telematics terminal 100, data from the data detection unit 50 (S100).

When the data detection unit 50 detects the data, and transmits the detected data to the telematics terminal 100, the telematics terminal 100 may be configured to determine a weather state (S110). The weather state may include rainfall, snowfall, fog, and yellow dust. The telematics terminal 100 may be configured to transmit position information of a vehicle and weather state information to the telematics server 200 for each predetermined period, and the telematics server 200 may be configured to receive the position information of the vehicle and the weather state information (S120). A period, which may be determined by a person of an ordinary skill in the art considering a load of the network, may be set as the predetermined period (e.g., a period of time). The telematics server 200 may be configured to identify a link that corresponds to the position of the vehicle, and store weather state information regarding the corresponding link (S130). In other words, as the amount of weather state information collected from the plurality of telematics terminals 100 increases, the weather state information regarding the corresponding link may be accumulated.

The telematics server 200 may be configured to generate current weather information regarding the corresponding link (S140). The current weather information may include current rainfall amount information, current rainfall amount information, current visibility range information according to fog, current visibility range information according to yellow dust, and the like. For example, the telematics server 200 may be configured to collect information regarding the rainfall amount of the corresponding link from the plurality of telematics terminals 100, and determine the current amount of rain fall using a statistical analysis based on the collected information. Further, the telematics server 200 may be configured to collect image information regarding fog of the corresponding link from the plurality of telematics terminals 100, and determine a level (or seriousness) of fog by performing image processing, such as removal of noise. The telematics server 200 may be configured to convert the determined level of fog into a visibility range, and generate current visibility range information based on the fog. The telematics server 200 may be configured to store the generated current weather information regarding the corresponding link (S150). Accordingly, the telematics server 200 may be configured to generate and store current weather information for each link.

FIG. 4 is an exemplary flowchart illustrating a method of providing weather information according to an exemplary embodiment of the present invention. Referring to FIG. 4, when a driver selects a destination, the telematics terminal 100 may be configured to set a desired route from a current position of a vehicle to a destination (S200). In particular, the telematics terminal 100 may be configured to calculate one or more routes from the current position to the destination, and the driver may select the desired route among the one or more routes.

The driver may request weather information via the telematics terminal 100 (S210). In particular, the telematics terminal 100 may be configured to transmit information regarding the desired route to the telematics server 200 (S220). The telematics server 200 may be configured to search for current weather information that corresponds to the desired route (S230). The telematics server 200 may be configured to transmit the current weather information that corresponds to the desired route to the telematics terminal 100, and the telematics terminal 100 may be configured to receive the current weather information that corresponds to the desired route from the telematics server 200 (S240). The telematics terminal 100 may be configured to map the current weather information to map data, and display the mapped current weather information (S250). The current weather information may include current weather information for each link (e.g., different locations along the route) included in the desired route. Accordingly, the driver may confirm a link having bad weather in the desired route and chose a detour (e.g. select a different or alternate route).

As described above, according to the exemplary embodiment of the present invention, it may be possible to collect weather information regarding a specific link using the telematics terminal disposed within the vehicle without using a separate device. Further, it may be possible to improve safety for a driver by providing the driver with current weather information.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

### DESCRIPTION OF SYMBOLS

1: Vehicle
2: Telematics center
3: Satellite
100: Telematics terminal
200: Telematics server

What is claimed is:

1. A method of providing weather information, comprising:
setting, by a controller, a desired route from a current position of a vehicle to a destination;
transmitting, by the controller, information regarding the desired route to a telematics server;
receiving, by the controller, current weather information that corresponds to the desired route from the telematics server; and
mapping, by the controller, the current weather information with map data and displaying the mapped current weather information.

2. The method of claim 1, wherein the current weather information includes current weather information for each link included in the desired route.

3. The method of claim 2, wherein the current weather information for each link is generated by the telematics server based on position information and weather state information collected from a plurality of telematics terminals.

4. The method of claim 2, wherein the current weather information for each link includes at least one of a group selected from: current rainfall amount information, current snowfall amount information, current visibility range information according to fog, and current visibility range information according to yellow dust.

5. The method of claim 4, further comprising:
selecting, by the controller, an alternate route in response to determining one of the current weather information for each link.

6. A system for providing weather information, comprising:
a telematics terminal configured to detect data from a data detection unit disposed within a vehicle, and determine a weather state; and
a telematics server configured to receive position information of the vehicle and weather state information from the telematics terminal,
wherein the telematics server is configured to identify a link that corresponds to a position of the vehicle and store the weather state information regarding the corresponding link.

7. The system of claim 6, wherein the data detection unit includes:
a rain sensor configured to detect rainfall; and
an imaging device configured to photograph an exterior of the vehicle,
wherein the weather state includes rainfall, snowfall, fog, and yellow dust.

8. The system of claim 6, wherein the telematics terminal is configured to transmit the position information of the vehicle and the weather state information for each predetermined period.

9. The system of claim 6, wherein the telematics server is configured to generate current weather information regarding the corresponding link.

10. A non-transitory computer readable medium containing program instructions executed by a controller, the computer readable medium comprising:
program instructions that set a desired route from a current position of a vehicle to a destination;
program instructions that transmit information regarding the desired route to a telematics server;
program instructions that receive current weather information that corresponds to the desired route from the telematics server; and
program instructions that map the current weather information with map data and display the mapped current weather information.

11. The non-transitory computer readable medium of claim 10, wherein the current weather information includes current weather information for each link included in the desired route.

12. The non-transitory computer readable medium of claim 11, wherein the current weather information for each link is generated by the telematics server based on position information and weather state information collected from a plurality of telematics terminals.

13. The non-transitory computer readable medium of claim 11, wherein the current weather information for each link includes at least one of a group selected from: current rainfall amount information, current snowfall amount information, current visibility range information according to fog, and current visibility range information according to yellow dust.

14. The non-transitory computer readable medium of claim 13, further comprising:
program instructions that select an alternate route in response to determining one of the current weather information for each link.
